(19) United States
(12) Patent Application Publication
(10) Pub. No.: US 2021/0056474 A1
(43) Pub. Date: Feb. 25, 2021

(54) INFORMATION PROCESSING SYSTEM, INFORMATION PROCESSING METHOD, AND RECORDING MEDIUM

(71) Applicant: Kensuke TANAKA, Tokyo (JP)

(72) Inventor: Kensuke TANAKA, Kanagawa (JP)

(21) Appl. No.: 16/959,281

(22) PCT Filed: Feb. 1, 2019
(86) PCT No.: PCT/JP2019/003612

§ 371 Date: Jun. 30, 2020

(30) Foreign Application Priority Data
Mar. 2, 2018 (JP) 2018-037926

(51) Int. Cl. G06Q 10/06

(52) U.S. Cl. CPC G06Q 10/0633; H04N 1/04

(57) ABSTRACT

An information processing system and an information processing method, each of which: stores in a first storage area definition information of a workflow, the workflow including one or more processing each processing having been selected for execution by one or more programs; stores in a second storage area setting information for setting processing controlled not to be executed; changes setting of the workflow so as not to execute the processing set by the setting information when executing the one or more processing of the workflow.

### TECHNICAL FIELD

The present invention relates to an information processing system, an information processing method, and a recording medium.

### BACKGROUND ART

The document distribution system distributes a document by an electronic mail or distributes a document to a predetermined folder, and the document may be applied with some processing before being distributed. For example, a user using the document distribution system can select and set processing to be applied to image data generated by reading an original with a scanner or the like. A processing mode in which a plurality of processing is applied to one document in this manner is referred to as a workflow, and information defining how the workflow executes the processing is referred to as definition information of the workflow.

An administrator of the document distribution system can register the definition information of a plurality of workflows in a distribution server in advance. With the registration, the user can execute one or more processing defined in the definition information for a document (for example, image data) by simply selecting a desired workflow. Further, a technology of automatically selecting an optimum workflow from a plurality of workflows has been devised. PTL 1 discloses a document distribution system that automatically selects an optimum workflow from user's authentication information and attribute information set in advance for each workflow.

### CITATION LIST

### Patent Literature

PTL 1: JP-2012-044386-A

### SUMMARY OF INVENTION

### Technical Problem

However, in the document distribution system disclosed in PTL1, the workflow may not be optimized even if the optimum workflow is selected. In one example, this is due to the granularity of each processing included in the workflow. For example, in a case where certain processing A requires sub-processing, the sub-processing is performed in the processing A but another processing B may have the same sub-processing in some cases. In such case, the same sub-processing is redundantly executed in the workflow including the processing A and the processing B.

In another example, this is due to existence of processing that are not compatible with each other. For example, in the workflow in which the processing A and the processing B are executed in succession, the processing B may not be compatible with a file format of data output by the processing A in some cases. In this case, there is a possibility that the workflow cannot be executed to the end because no file is input to the processing B.

Note that such a problem may arise when an optimum workflow is automatically selected and also when the user selects a workflow.

### Solution to Problem

Example embodiments of the present invention include an information processing system including: a first storage area that stores definition information of a workflow, the workflow including one or more processing each processing having been selected for execution by one or more programs; a second storage area that stores setting information for setting processing controlled not to be executed; and a processor to change setting of the workflow so as not to execute the processing set by the setting information when executing the one or more processing of the workflow.

Example embodiments of the present invention include an information processing method including: acquiring, from a first storage area, definition information of a workflow, the workflow including one or more processing each processing having been selected for execution by one or more programs; determining whether the workflow includes any processing controlled not to be executed, using setting information for setting the processing controlled not to be executed stored in a second storage area; and changing setting of the workflow so as not to execute the processing set by the setting information when executing the one or more processing of the workflow.

Example embodiments of the present invention include a recording medium carrying computer readable code for controlling a computer system to carry out the above-described method.

### Advantageous Effects of Invention

With the above-described configuration, a workflow can be optimized.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating an example of a setting screen for newly creating definition information of a workflow.

FIGS. 2A and 2B are diagrams illustrating examples of the setting screen of a workflow.

FIG. 3 is a diagram illustrating an example of the definition information of a workflow.

FIG. 4 is a diagram illustrating an example of a detailed setting screen of a plug-in called mail transmission.

FIG. 5 is an example of a schematic configuration diagram of a document distribution system.

FIG. 6 is a diagram illustrating a hardware configuration example of a distribution server.

FIG. 7 is an example of a functional block diagram illustrating functions of a scanner device and the distribution server according to a first embodiment.

FIGS. 8A and 8B are diagrams illustrating an example of the definition information of the workflow stored in a definition information storage unit.

FIG. 9 is an example of a diagram illustrating optimization setting stored in an optimization setting storage unit according to the first embodiment.

FIG. 10 is a diagram illustrating an example of the definition information of the workflow optimized by the definition information optimization unit.

FIG. 11 is an example of a flowchart illustrating a procedure of deleting redundant processing by the definition information optimization unit.

FIG. 12 is an example of a functional block diagram illustrating functions of a scanner device and a distribution server according to a second embodiment.

FIG. 13 is an example of a diagram illustrating optimization setting stored in an optimization setting storage unit according to the second embodiment.

FIG. 14 is an example of a flowchart illustrating a procedure of invalidating processing on the basis of file formats of successive processing by a definition information optimization unit.

FIG. 15 is an example of a functional block diagram illustrating functions of a scanner device and a distribution server according to a third embodiment.

FIG. 16 is an example of a diagram illustrating optimization setting stored in an optimization setting storage unit according to the third embodiment.

FIG. 17 is an example of a diagram illustrating a mail address set to two different mail distributions.

FIG. 18 is an example of a flowchart illustrating a procedure of deleting a redundant distribution destination by a definition information optimization unit.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a document distribution system and an information processing method performed by a distribution server of the document distribution system will be described as examples of modes for implementing the present invention with reference to the drawings.

### First Embodiment

In describing a document distribution system of the present embodiment, definition information of a workflow executed in the document distribution system will be described.

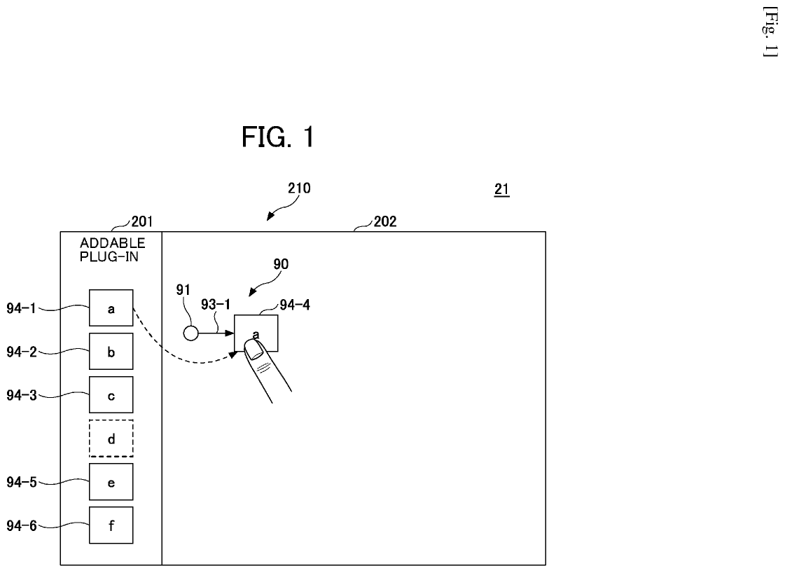

FIG. 1 is a diagram illustrating an example of a setting screen 210, displayed at the time of newly creating definition information of a workflow. In the present embodiment, description will be given on the assumption that setting of a workflow is performed in a scanner device operated by an administrator of the document distribution system. However, the workflow may be set by a terminal used by the administrator or a terminal used by a general user. The workflow is defined by setting the workflow (the definition information is generated).

The scanner device communicates with a distribution server to be described below and displays the setting screen 210. The setting screen 210 includes a plug-in list column 201 in which a list of addable plug-ins (programs) is displayed and a workflow definition column 202. In the plug-in list column 201, icons 94 (94-1 to 94-6) indicating all of plug-ins executable by the distribution server are displayed. In this disclosure, a plug-in is a minimum unit of processing viewed from the administrator or the user, and is actually a program.

As illustrated in FIG. 1, a flowchart 90 including a start mark 91 is displayed in the workflow definition column 202 at the time of newly creating a workflow. The scanner device adds execution of a new plug-in to a workflow to create the definition information of the workflow as the administrator adds the icon 94 to the flowchart 90 including the start mark 91. The administrator moves the icon on an operation unit 21 of the scanner device in this manner to newly create the definition information of the workflow.

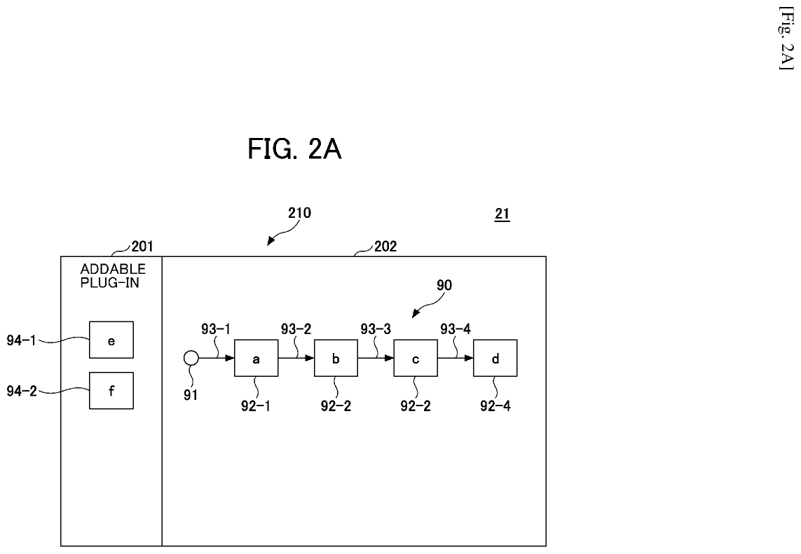

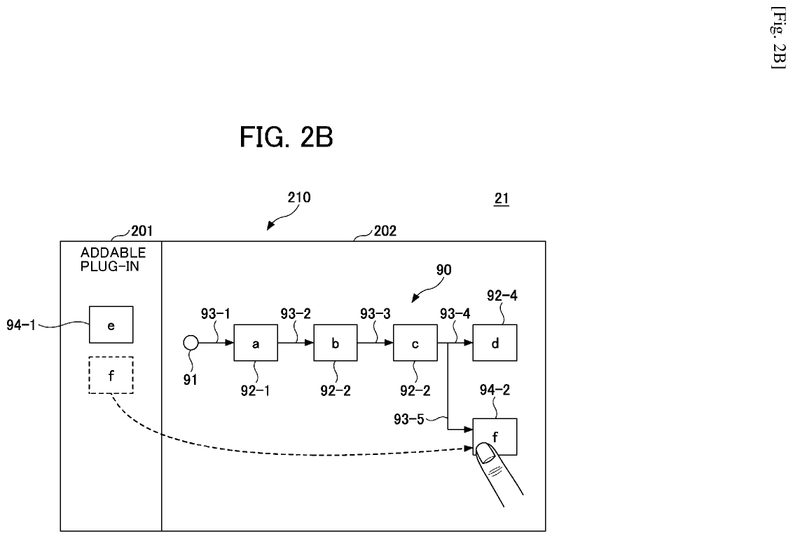

FIGS. 2A and 2B are diagrams illustrating examples of the setting screen of the workflow. FIG. 2A illustrates the setting screen 210 on which the flowchart 90 of the workflow created halfway is displayed. Note that the workflow may just have at least one plug-in, and the workflow may be completed in the flowchart 90 in FIG. 2A. The flowchart 90 includes the start mark 91 indicating start, icons 92 (92-1 to 92-4) indicating plug-ins to be executed, and arrows 93 (93-1 to 93-4). The arrows 93 connect the start mark 91 and the icons 92, and represent the order of execution of the plug-ins.

FIG. 2B illustrates the setting screen 210 when a plug-in is added to FIG. 2A. The scanner device adds execution of a new plug-in to the workflow in response to the administrator performing an operation to add the icon 94-2 displayed in the plug-in list column 201 to the flowchart 90. The administrator can define the workflow by the operation to add a plug-in to the flowchart in this manner, and the scanner device (or the distribution server) can create the definition information of the workflow according to the flowchart. The created definition information of the workflow is registered to the distribution server.

The method for newly creating a workflow has been described in FIGS. 1 and 2, but the administrator can edit or improve an already defined workflow. The administrator downloads the workflow from the distribution server to the scanner device. The scanner device can delete or add a plug-in already incorporated in the workflow, or can change the execution order of plug-ins already incorporated in the workflow in response to the operation of the administrator. In addition, the administrator may prohibit such operations at the time of registering the workflow to the distribution server.

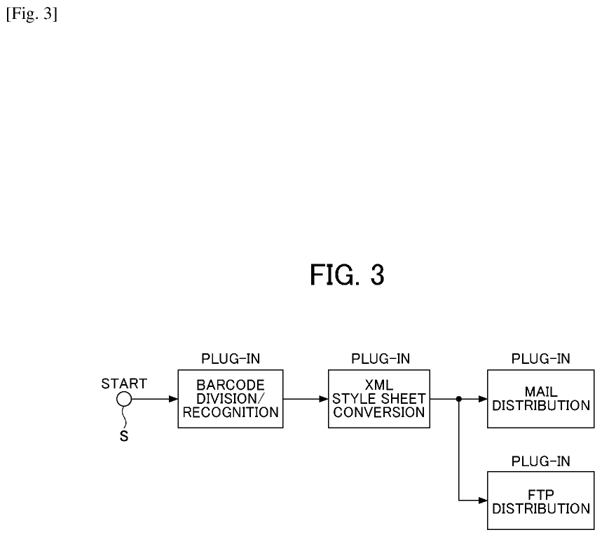

FIG. 3 is a diagram illustrating an example of the definition information of the workflow. In a case where the scanner device performs scan processing, the distribution server executes the plug-in in accordance with the definition information of the workflow as illustrated in FIG. 3, for example.

According to FIG. 3, the distribution server executes, as first processing, a plug-in to segment/recognize a barcode, for example, when receiving image data scanned by the scanner device. The barcode segmentation/recognition processing is processing of extracting a barcode at a predetermined position in the image data from the image data and obtaining content of the barcode.

Next, the distribution server executes, as second processing, a plug-in to perform extensible markup language (XML) style sheet conversion. The XML style sheet conversion is processing of converting bibliographic information of image data into data in the XML format.

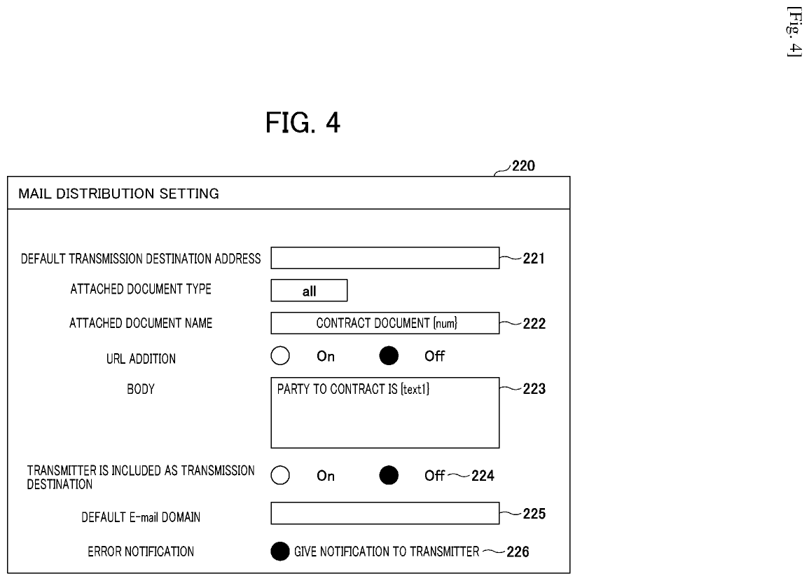

Next, the distribution server executes, as third processing, a plug-in to distribute a mail. The mail distribution is processing of transmitting image data (electronic data processed by the distribution server and not limited to image data) by an electronic mail to a destination described below in FIG. 4. Further, the distribution server executes, as fourth processing, a plug-in to perform file transfer protocol (FTP) distribution in parallel to the third processing (folder distribution). The FTP distribution is processing of transmitting data to an FTP server on a network by FTP and accumulating the data.

Further, when the administrator double-clicks any of the plug-ins in the workflow definition column 202, the scanner device displays a detailed setting screen for setting details of the plug-in.

FIG. 4 is a diagram illustrating an example of a detailed setting screen 220 of a plug-in called mail transmission. The detailed setting screen 220 illustrated in FIG. 4 includes a transmission destination address setting area 221, an attached document name setting area 222, and a body setting area 223. Further, the detailed setting screen 220 includes a setting column 224 as to whether to include the transmitter in the transmission destination, a default (initial setting) electronic mail domain setting column 225, and a setting column 226 regarding presence/absence of error notification. In FIG. 4, the detailed setting screen 220 of the plug-in of mail transmission has been described, but the detailed setting screen 220 corresponding to processing of another plug-in is also displayed for the another plug-in.

As described above, in one step of processing selectable by the administrator using the setting screen 210, a plug-in selected and mounted by the user is the minimum unit (minimum granularity). A plug-in is a program that executes processing. The plug-in may have sub-processing overlapping with another plug-in, such as the plug-in executing top to bottom processing for executing an optical character reader (OCR) or executing top to bottom processing for pressing a stamp. In this disclosure, the sub-processing is any processing, which is included in one processing (main processing) to be performed to complete the main processing.

To prevent each plug-in from having the redundant sub-processing, the granularity of the processing may be made small, but the convenience may be impaired if the granularity of the processing selected by the user via the setting screen 210 becomes small. Therefore, each plug-in is not created in consideration of whether the redundant sub-processing is performed in another plug-in. Further, whether the user may execute the plug-in having the redundant sub-processing depends on the user.

Even if the redundancy is not eliminated, execution of the workflow becomes hardly difficult, and there is a risk that the time required for the workflow becomes long or the processing load on the distribution server increases. Therefore, in the case where one workflow has the redundant sub-processing as in FIG. 3, elimination of the redundancy is favorable.

In this disclosure, a workflow is one or more processing executed for electronic data. The workflow includes a case where the order of the processing is determined. The electronic data output by the workflow by the series of processing may be a plurality of electronic data. Processing may not be called workflow as long as the processing includes one or more processing. The one or more processing may be called cooperative processing or continuous processing.

Control not to be executed means not to be executed by any method. For example, there is a method for deleting processing from the definition information of the workflow, a method for invalidating the definition information of the workflow, or a method for replacing processing with dummy processing that is actually not processed.

Further, the administrator of the document distribution system refers to a person who mainly defines a workflow and the user refers to a person who executes the defined workflow. Note that there are cases where the administrator becomes the user, and the distinction between the administrator and the user is merely for convenience.

Further, the document distribution system may just be a system or an apparatus that outputs electronic data for which one or more processing have been executed. Therefore, the document distribution system may be called electronic data output system or the like. Further, the document distribution system may be called a workflow system as a system corresponding to a workflow, or the like.

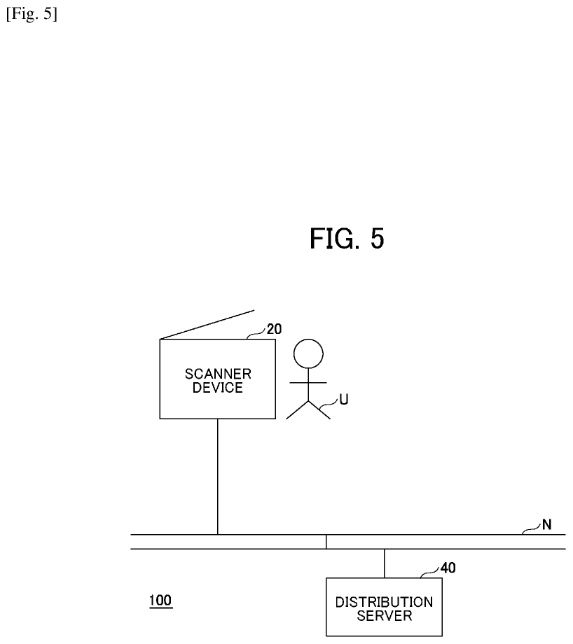

FIG. 5 illustrates an example of a schematic configuration diagram of a document distribution system 100. The document distribution system 100 includes a distribution server 40 and one or more scanner devices 20 communicatively connected via a network N. FIG. 5 merely illustrates the devices used in the description of the present embodiment, and the document distribution system 100 may include devices other than the illustrated devices. For example, a data accumulation device that accumulates documents processed by the distribution server, an administrator terminal, a user terminal, and the like may be connected to the network N.

The network N may include a local area network (LAN) in a facility where the scanner device 20 is provided, a wide area Ethernet (registered trademark), a wide area network (WAN) connected by a virtual private network (VPN), and the Internet. Besides the above, the network N can be configured by any means capable of performing communication.

The scanner device 20 is an example of an image capture device, and scans an original document to generate image data. The scanner device 20 may be a multifunction peripheral having at least one of a facsimile function, a copy function, and a printer function in addition to the scanner function. The scanner device 20 transmits the generated image data to the distribution server 40 via the network N.

As a device that creates the image data, a digital still camera or a digital video camera may be used. The device may not be a device that receives an input of an image and may be a device that receives an input of electronic data that is to be processed by the distribution server 40. For example, the device may be a video conference terminal, an electronic blackboard, a personal computer (PC), or a storage medium such as a universal serial bus (USB) memory.

The distribution server 40 includes one or more information processing apparatuses and corresponds to an information processing system. The distribution server 40 acquires image data from at least one scanner device 20.

The distribution server 40 executes at least one step of processing for the image data acquired from the scanner device 20 in a predetermined order. The distribution server 40 is favorably compatible with cloud computing. Cloud computing is a use form in which resources on a network are used without being conscious of a specific hardware resource.

As an example, the distribution server 40 executes filter processing (image correction, file format conversion, character recognition, barcode reading, document information extraction, and the like) for the image data acquired from the scanner device 20. Then, the distribution server 40 transmits the image data acquired from the scanner device 20 and various kinds of document information generated by file processing to a predetermined information processing apparatus by mail distribution, folder distribution, and the like, and accumulates the image data and the document information.

For the accumulation of documents, a file server that manages shared folders of Windows (registered trademark), a file transfer protocol (FTP) server, a web-based distributed authoring and versioning (WebDAV) server, or a mail server is used, for example.

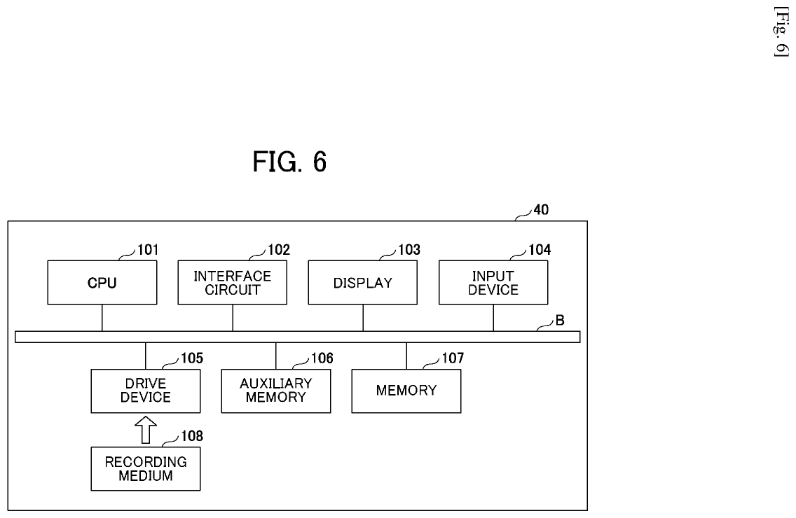

FIG. 6 is a diagram illustrating a hardware configuration example of the distribution server 40 in the present embodiment. The distribution server 40 includes a central processing unit (CPU) 101, an interface circuit 102, a display 103, an input device 104, a drive device 105, an auxiliary memory 106, and a memory 107 mutually connected by a bus B.

The CPU 101 expands a program stored in the auxiliary memory 106 to the memory 107 and executes the program to implement functions regarding the whole of processing of the distribution server 40. The interface circuit 102 is a communication device that is connected to the network N and performs communication processing. The display 103 displays a graphical user interface (GUI) generated by the CPU. The input device 104 includes a keyboard, a mouse, and the like, and is used for inputting various operation instructions.

The drive device 105 is a device that reads and writes information from and to a recording medium 108 such as a compact disc read-only memory (CD-ROM). The auxiliary memory 106 is a nonvolatile large-capacity storage device, and is, for example, a hard disk drive or a solid state drive. The memory 107 is a volatile storage device capable of reading and writing data at high speed.

The program stored in the auxiliary memory 106 may be distributed in a state of being stored in the recording medium 108 and installed in the distribution server 40 via the drive device 105, or may be downloaded from a program distribution server via the interface circuit 102 and installed in the distribution server 40. This program includes various plug-ins.

Note that the hardware of the scanner device 20 may have a known configuration but at least a document reading function (scanner) is included in the configuration as the information processing apparatus in FIG. 6.

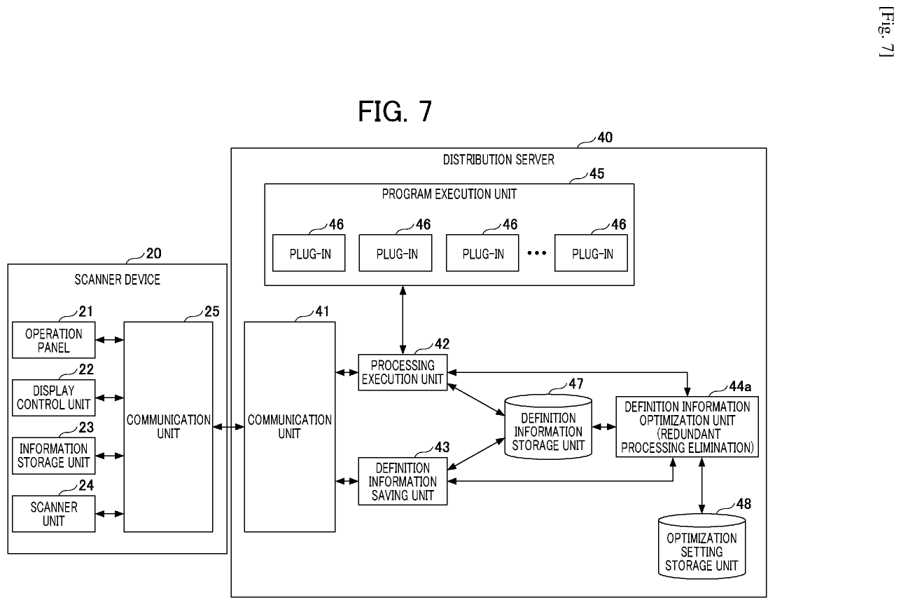

FIG. 7 is an example of a functional block diagram illustrating functions of the scanner device 20 and the distribution server 40 according to the present embodiment.

The scanner device 20 includes the operation unit 21, a display control unit 22, an information storage unit 23, a scanner unit 24, and a communication unit 25. The functions of the scanner device 20 are functions implemented by the CPU of the scanner device 20 executing the program stored in a hard disk drive (HDD) or the like and controlling the hardware of the scanner device 20.

The operation unit 21 displays a screen for the user U and receives an operation input from the user U via an operation button and a text input box. The operation unit 21 is implemented by an operation panel (control panel), and includes, for example, a touch panel and various operation buttons.

The display control unit 22 controls the operation unit 21. The information storage unit 23 stores an image to be displayed on the operation unit 21 and information input to the operation unit 21. The scanner unit 24 scans a sheet or the like set on a copy table to generate image data.

The communication unit 25 communicates with the distribution server 40 via the network N. The communication unit 25 is implemented by a network interface circuit as an example. The communication unit 25 acquires the information and the like to be displayed on the operation unit 21 from the distribution server 40, and transmits the input information for the operation unit 21 to the distribution server 40, as an example. Further, the communication unit 25 transmits the image data scanned by the scanner unit 24 to the distribution server 40, as an example.

The distribution server 40 includes a communication unit 41, a processing execution unit 42, a definition information saving unit 43, a definition information optimization unit 44a, and a program execution unit 45. The functions of the distribution server 40 are functions implemented by the CPU 101 of the distribution server 40 illustrated in FIG. 6 executing a program stored in the auxiliary memory 106 or the like and controlling the hardware elements of the distribution server 40.

Further, the distribution server 40 includes a definition information storage unit 47 and an optimization setting storage unit 48, each constructed by the auxiliary memory 106 or the memory 107 illustrated in FIG. 6. First, these units will be described.

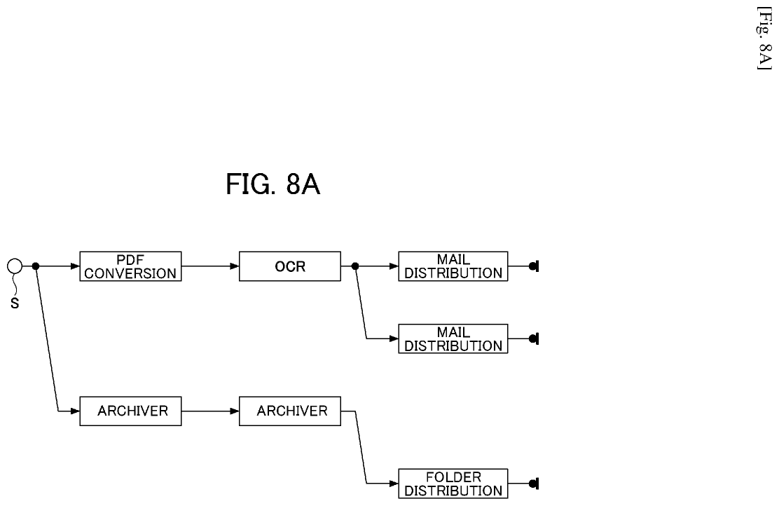

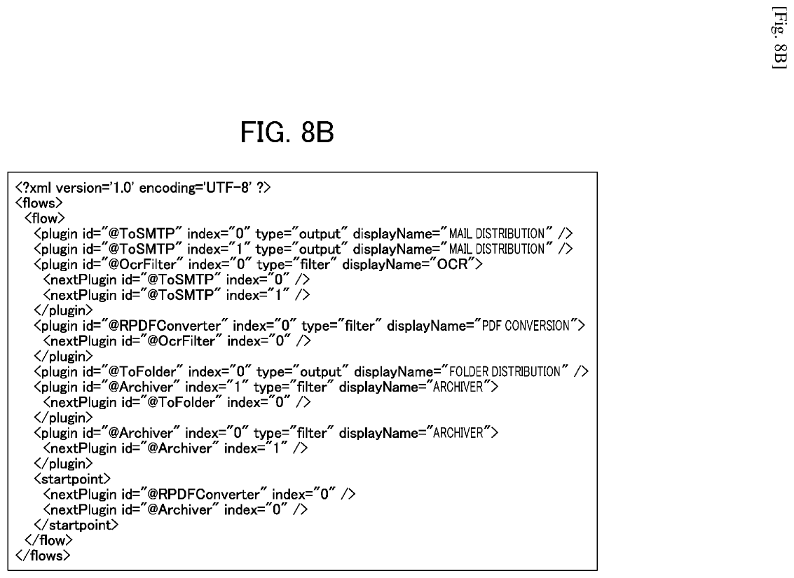

FIGS. 8A and 8B are diagrams illustrating an example of the definition information of the workflow stored in the definition information storage unit 47. FIG. 8A illustrates a workflow by a flowchart and FIG. 8B illustrates the definition information of the workflow illustrating the workflow in FIG. 8A in an XML format. The workflow illustrated in FIG. 8A illustrates series of processing of start S→portable document format (PDF) conversion→OCR→mail distribution×2 and start S→archiver→archiver→folder distribution, and the order of the processing. An archiver refers to decompressing a compressed file.

The definition information of the workflow in FIG. 8B is described such that the workflow proceeds from the bottom to the top. The definition information of the workflow will be described in order from the bottom.

<startpoint>
<nextPlugin id=″@RPDFConverter″ index=″0″ />
<nextPlugin id=“@Archiver” index=“0” />
</startpoint>

These descriptions indicate that the workflow starts from the PDF conversion and archiver processing (startpoint).

<plugin id=“@Archiver” index=“0” type=“filter”
displayName=“archiver”>
<nextPlugin id=″@Archiver″ index=″1″ />
</plugin>

These descriptions indicate that the archiver (index=“0”) is intermediate processing (filter), and notation in the scanner device 20 is “archiver”. Further, the description indicates that the next processing (nextPlugin) is archiver (index=“1”).

<plugin id=″@Archiver″ index=″1″ type=″filter″
displayName=″archiver″>
<nextPlugin id=″@ToFolder″ index=″0″ />
</plugin>

These descriptions indicate that the archiver (index=“1”) is intermediate processing (filter), and notation in the scanner device 20 is “archiver”. Further, the description indicates that the next processing (nextPlugin) is folder distribution.

<plugin id=″@ToFolder″ index=″0″ type=″output″
displayName=″folder distribution″ />

This description indicates that folder distribution is output processing (output), and notation in the scanner device 20 is “folder distribution”. Note that the next processing is not defined.

<plugin id=″@RPDFConverter″ index=″0″ type=″filter″
displayName=″PDF conversion″>
<nextPlugin id=″@OcrFilter″ index=″0″ />
</plugin>

These descriptions indicate that the PDF conversion is intermediate processing (filter) and notation in the scanner device 20 is “PDF conversion”. Further, the description indicates that the next processing (nextPlugin) is OCR.

<plugin id=″@OcrFilter″ index=″0″ type=″filter″
displayName=″OCR″>
<nextPlugin id=″@ToSMTP″ index=″0″ />
<nextPlugin id=″@ToSMTP″ index=″1″ />
</plugin>

These descriptions indicate that the OCR is intermediate processing (filter) and notation in the scanner device 20 is “OCR”. Further, the description indicates that the next processing (nextPlugin) is mail transmission (index=“0”) and mail transmission (index=“1”).

<plugin id=″@ToSMTP″ index=″0″ type=″output″
displayName=″mail distribution″ />

This description indicates that the mail transmission (index=“0”) is output processing (output), and notation in the scanner device 20 is “mail distribution”. Note that the next processing is not defined.

<plugin id=″@ToSMTP″ index=″1″ type=″output″
displayName=″mail distribution″ />

This description indicates that the mail transmission (index=“1”) is output processing (output), and notation in the scanner device 20 is “mail distribution”. Note that the next processing is not defined.

In FIG. 8B, the definition information of the workflow is described in the XML format. However, the definition information of the workflow may be described in a JavaScript Object Notation (JSON) format, a comma-separated values (CSV) format, or a text format, and the format of the definition information of the workflow is not limited to the aforementioned formats.

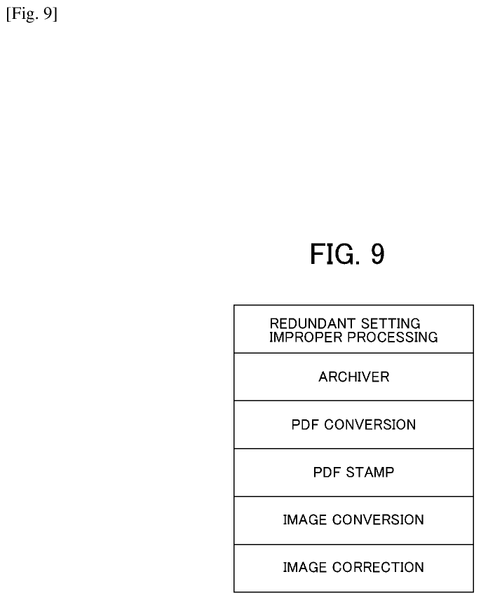

Next, the optimization setting storage unit 48 will be described with reference to FIG. 9. FIG. 9 illustrates optimization setting stored in the optimization setting storage unit 48. The optimization setting (an example of the setting information) of the present embodiment sets a list of “redundant setting improper processing” that are ineffective even if the processing are to be redundantly performed. That is, since the archiver is decompression processing, there is no need to redundantly execute the archiver, and there is also no need to redundantly execute the PDF conversion if once executed. The same applies to PDF stamp, image conversion, and image correction. Processing controlled not to be redundantly executed is set to the optimization setting. More specifically, for example, processing having redundant sub-processing are set to the optimization setting.

Note that the distribution server 40 may determine that the processing is redundant in a case where one workflow has the same processing in succession instead of a case where the workflow redundantly has the same processing (processing set to the optimization setting). This is because the same processing may be required again in processing between the same processing in a case where the same processing are separated.

Description will be given referring back to FIG. 7. The communication unit 41 communicates with the scanner device 20 via the network N. In the present embodiment, the communication unit 41 receives the image data and the definition information of the workflow. The program execution unit 45 has a plurality of pre-registered plug-ins 46 and executes the plug-ins according to the control of the processing execution unit 42. The plug-in 46 corresponds one-to-one with processing. In principle, the plug-ins 46 execute processing different from one another, but the plug-ins 46 that execute the same processing may exist.

The processing execution unit 42 communicates with the program execution unit 45 to execute the workflow selected by the user. When an instruction on the workflow to be executed is given by the user, the processing execution unit 42 reads out the definition information of the workflow stored in the definition information storage unit 47 and analyzes the processing and the order of the processing. Then, the processing execution unit 42 sends the image data to the plug-in 46 corresponding to the processing, and requests execution of the processing. When acquiring processed image data (may be converted into data in a different format from the image data) from the plug-in 46, the processing execution unit 42 repeats the request of processing to the plug-ins 46 in the order of the processing in the definition information of the workflow.

Prior to scanning of the image data by the scanner device 20, the definition information saving unit 43 receives editing of the selected definition information of the workflow in response to the operation of the administrator to the scanner device 20. As an example, the definition information saving unit 43 causes the operation unit 21 of the scanner device 20 to display the setting screen 210 of the workflow via the communication unit 41, and receives an editing operation for the workflow on the setting screen 210. There are a case where the workflow already stored in the definition information storage unit 47 is edited and a case where a workflow is newly created. Then, the definition information saving unit 43 causes the definition information storage unit 47 to store the edited definition information of the workflow or the definition information of the newly created workflow.

The definition information optimization unit 44a optimizes the definition information of the workflow by reference to the optimization setting stored in the optimization setting storage unit 48. More specifically, in a case where two or more same processing as the processing in the optimization setting are redundantly included in the definition information of the workflow, one step of the same processing is left and the other same processing are deleted. Note that the definition information optimization unit 44a may delete the redundant processing at timing when the definition information of the workflow is stored in the definition information storage unit 47 or may delete the redundant processing at timing when the processing execution unit 42 executes the workflow.

<Definition Information After Deletion of Redundant Processing>

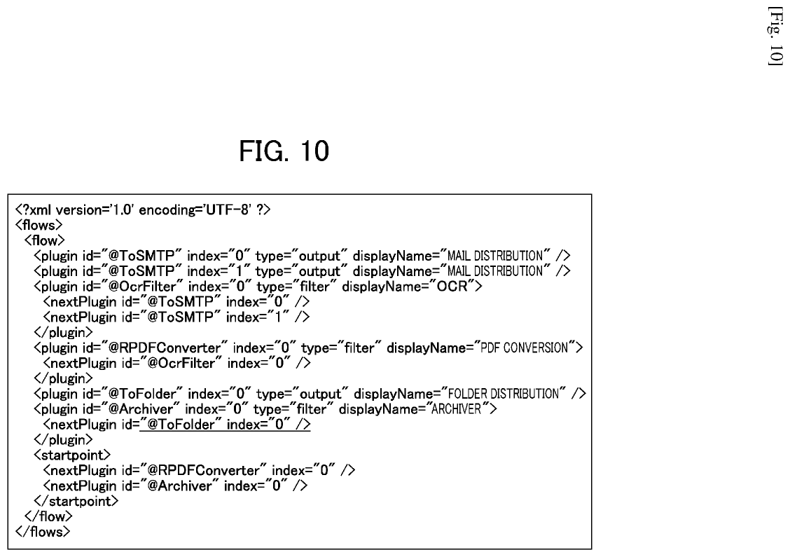

FIG. 10 illustrates an example of the definition information of the workflow optimized by the definition information optimization unit 44a. When comparing FIG. 10 with FIG. 8B, there are following changes.

<plugin id=“@Archiver” index=“0” type=“filter”
displayName=“archiver”>
<nextPlugin id=″@ToFolder″ index=″0″ />

That is, the processing following the archiver (index=“0”) is changed to folder distribution. In this way, the redundant processing is deleted such that the processing before the deleted processing and the processing after the deleted processing are linked.

In addition, the following processing of the archiver (index=“1”) that has been present in FIG. 8B is deleted.

“<plugin id=″@Archiver″ index=″1″ type=″filter″
displayName=″archiver″>
<nextPlugin id=″@ToFolder″ index=″0″ />
</plugin>″

In this way, the distribution server 40 can delete the redundant processing. Note that the archiver (index=“0”) may be deleted.

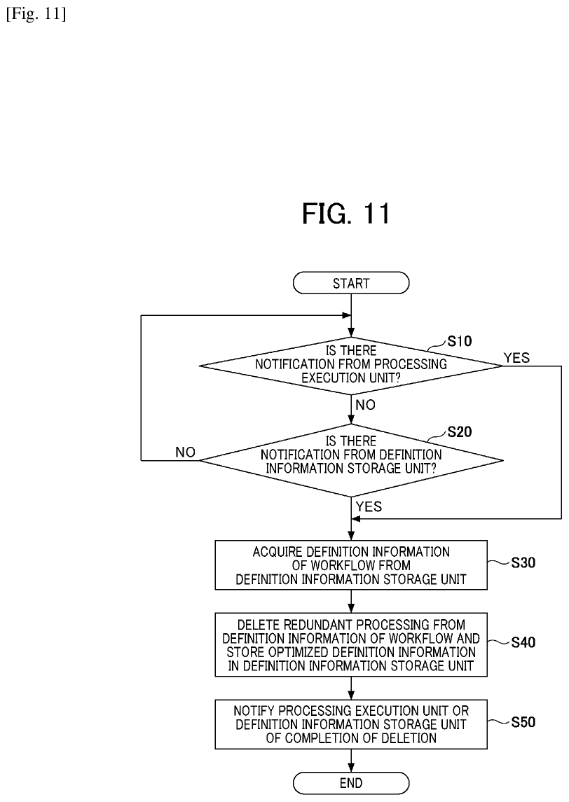

FIG. 11 is an example of a flowchart illustrating a procedure of deleting redundant processing by the definition information optimization unit 44a. Processing in FIG. 11 is executed during the distribution server 40 being activated.

First, the definition information optimization unit 44a determines whether there is a notification to execute the workflow from the processing execution unit 42 (S10). To avoid execution of redundant processing, the processing execution unit 42 notifies, in executing the workflow, the definition information optimization unit 44a that the workflow is to be executed.

Further, the definition information optimization unit 44a determines whether there is a notification that the definition information of the workflow has been saved in the definition information storage unit 47 from the definition information saving unit 43 (S20). Not to save the definition information of the workflow with redundant processing, the definition information saving unit 43 notifies, in saving the definition information of the workflow, the definition information optimization unit 44a that the definition information of the workflow is not to be saved. The definition information optimization unit 44a may monitor the saving of the definition information of the workflow to the definition information storage unit 47.

In a case where the determination in step S10 or S20 is Yes, the definition information optimization unit 44a acquires the definition information of the workflow from the definition information storage unit 47 (S30). The definition information optimization unit 44a acquires (reads) the definition information of the workflow from the definition information storage unit 47 on the basis of identification information of the definition information of the workflow given in notification from the processing execution unit 42 or the definition information saving unit 43.

Next, the definition information optimization unit 44a reads the optimization setting from the optimization setting storage unit 48, and deletes two or more processing set in the optimization setting and redundantly set in the definition information of the workflow. The definition information optimization unit 44a does not need to delete processing if the processing is not redundant. The definition information optimization unit 44a stores the optimized definition information of the workflow to the definition information storage unit 47 (S40). In a case where there are three or more same processing, one step of the same processing may just be left. In a case where the same processing are in succession, one step of processing may be left and the other processing may be deleted. Further, any of the redundant same processing may be left, but it is advisable to determine processing of deleting the same processing such that change of the definition information of the workflow becomes easy.

The definition information optimization unit 44a notifies the processing execution unit 42 or the definition information saving unit 43 that the deletion has been completed (S50). With the notification, the processing execution unit 42 can execute the workflow without redundant processing.

As described above, the distribution server 40 of the present embodiment deletes redundancy (deletes the redundant processing) in a case where one workflow has preset redundant processing. Therefore, the time to complete execution of the workflow can be shortened and an increase in the processing load of the distribution server 40 can be reduced. Further, there is no need to adjust the granularity of one step of processing, and the convenience when the user operates the setting screen is not impaired.

### Second Embodiment

In the second embodiment, a distribution server 40 that optimizes input and output between successive processing will be described. For example, in a case where processing A and processing B are in succession, and the processing B is not compatible with a file format generated by the processing A, the distribution server 40 invalidates the processing B to perform optimization. With the optimization, occurrence of a situation in which the workflow is interrupted in the unexecutable processing B and a processing result cannot be obtained can be reduced.

In the present embodiment, constituent elements denoted by the same reference numerals in the first embodiment serve similar functions, and thus main constituent elements of the present embodiment may be mainly described in some cases. For example, the system configuration diagram in FIG. 5 and the hardware configuration diagram in FIG. 6 are also incorporated in the present embodiment.

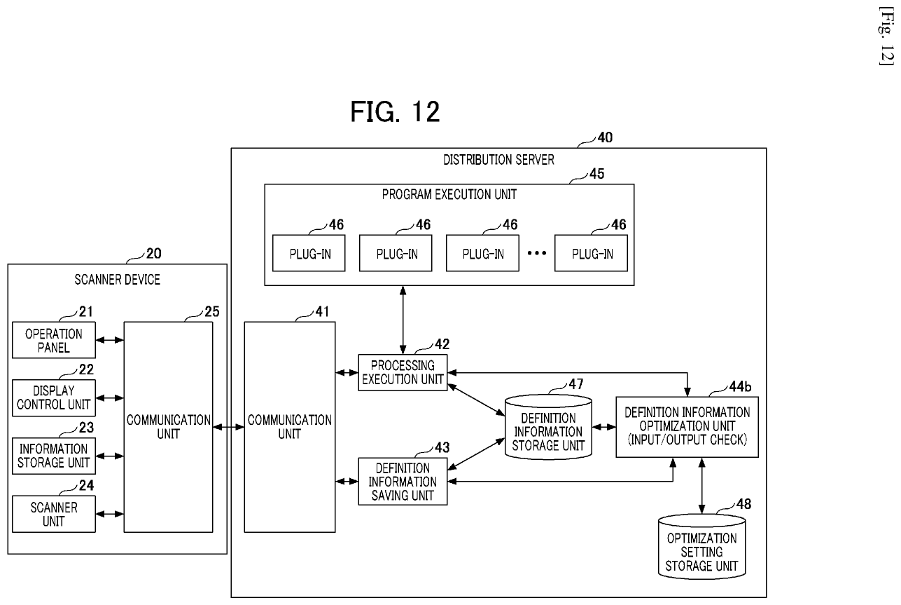

FIG. 12 is an example of a functional block diagram illustrating functions of a scanner device 20 and the distribution server 40 according to the present embodiment. In the description of FIG. 12, the difference from FIG. 7 will be mainly described. The configuration of the distribution server 40 is similar to the configuration in FIG. 7 but the way in which a definition information optimization unit 44b optimizes definition information of a workflow is different. Further, optimization setting stored in an optimization setting storage unit 48 in FIG. 12 is different from the optimization setting of the first embodiment.

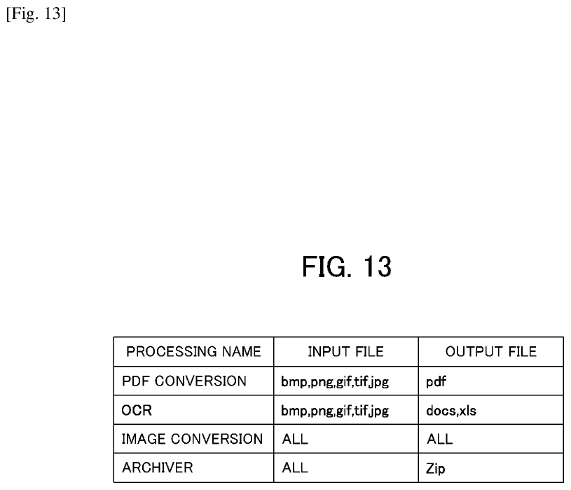

FIG. 13 illustrates optimization setting stored in the optimization setting storage unit 48 of the present embodiment. An input file and an output file are associated with each other for each processing in the optimization setting. The input file is any file that can be processed by a target processing to output data having an output file. For example, in processing called PDF conversion, the input files are bmp, png, gif, tif, and jpg, and the output file is pdf.

For example, a case where processing “PDF conversion”→“OCR” is included will be described as an example, as included in the definition information of the workflow in FIGS. 8A and 8B. According to FIG. 13, the output file “pdf” of the PDF conversion is not included in the input file in OCR. This means that the distribution server 40 cannot execute OCR. The definition information optimization unit 44b of the present embodiment invalidates the processing of OCR. Invalidation means changing definition information of a workflow so that processing is not executed or describing the change. For example, there is a method for making processing to be invalidated to a comment line according to a file format. Alternatively, the processing may be deleted similarly to the first embodiment.

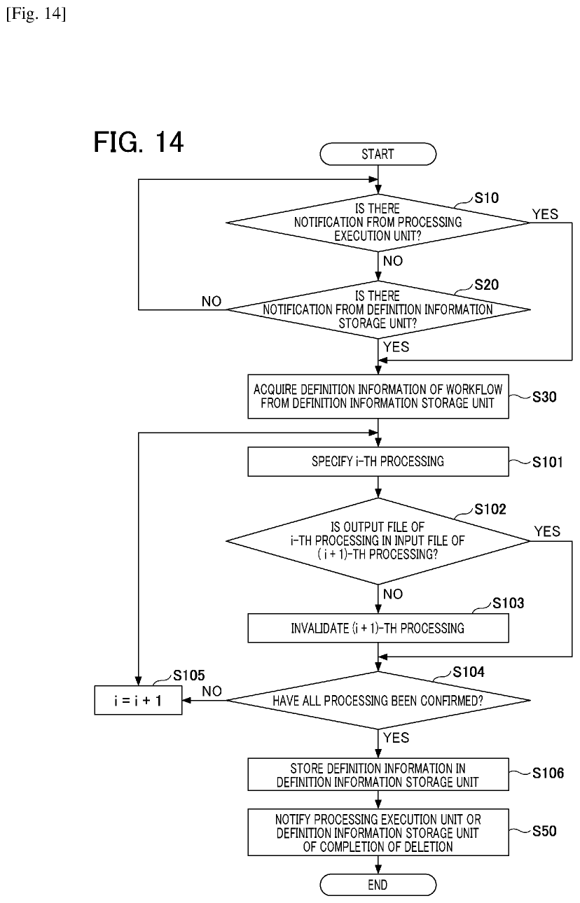

FIG. 14 is an example of a flowchart illustrating a procedure of invalidating processing on the basis of file formats of successive processing by a definition information optimization unit 44b. Processing in FIG. 14 is executed during the distribution server 40 being activated. Processing in steps S10 to S30 may be similar to steps S10 to S30 in FIG. 11.

Next, the definition information optimization unit 44b specifies the i-th processing (S101). Note that the initial value of i is 1 (start processing).

Next, the definition information optimization unit 44b determines whether the output file of the i-th processing is in the input files of the (i+1)-th processing by reference to the optimization setting stored in the optimization setting storage unit 48 (S102). In a case where the determination in step S102 is Yes, the processing proceeds to step S104.

In a case where the determination in step S102 is No, the (i+1)-th processing cannot be executed, and thus the definition information optimization unit 44b invalidates the (i+1)-th processing (S103).

Then, the definition information optimization unit 44b determines whether having confirmed all processing of one workflow (S104). In a case where the determination in step S104 is No, the definition information optimization unit 44b increments i by 1 (S105). Thereafter, the processing returns to step S101.

In a case where the determination in step S104 is Yes, the definition information optimization unit 44b stores the optimized definition information of the workflow to the definition information storage unit 47 (S106). Then, the definition information optimization unit 44b notifies a processing execution unit 42 or a definition information saving unit 43 that the optimization has been completed (S50).

As described above, the distribution server 40 according to the present embodiment determines the consistency between the output file of the previous processing and the input file of the subsequent processing, thereby to prevent halfway interruption of the processing of the workflow.

### Third Embodiment

In the present embodiment, a distribution server 40 that optimizes definition information of a workflow including a plurality of mail distributions will be described. For example, the definition information of a workflow illustrated in FIGS. 8A and 8B has processing of two mail distributions. However, distribution of a plurality of mails from one workflow is often wasteful. Conventionally, processing of excluding a redundant distribution destination (destination) in one mail distribution has been performed by the distribution server 40 but processing of deleting a redundant distribution destination between mail distribution A and mail distribution B has not been performed. In the present embodiment, the identity of the distribution destinations in the different distribution processing is confirmed in one workflow, and the redundant distribution destination is deleted in a case where the identity is confirmed, whereby distribution of a document to the same distribution destination can be avoided.

In the present embodiment, constituent elements denoted by the same reference numerals in the first embodiment serve similar functions, and thus main constituent elements of the present embodiment may be mainly described in some cases. For example, the system configuration diagram in FIG. 5 and the hardware configuration diagram in FIG. 6 are also incorporated in the present embodiment.

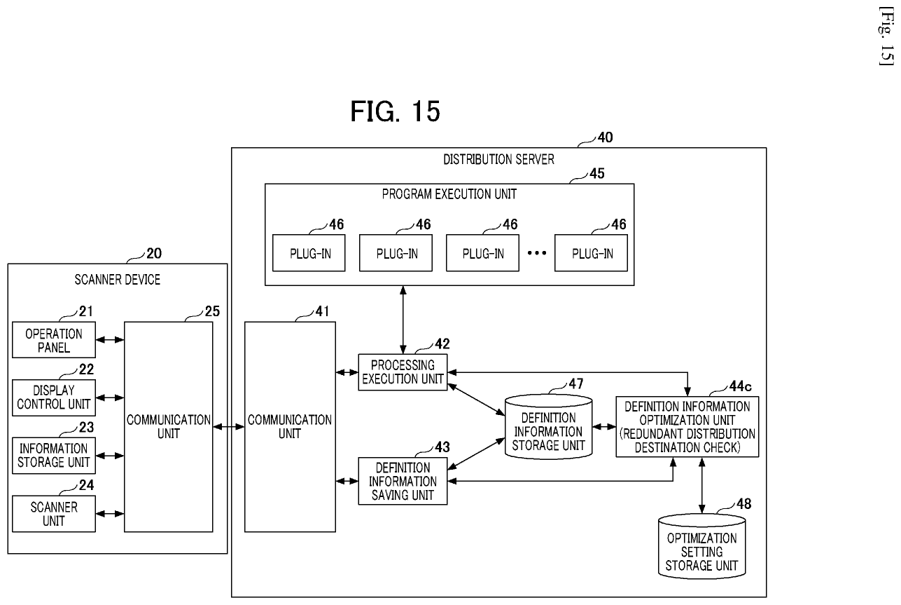

FIG. 15 is an example of a functional block diagram illustrating functions of a scanner device 20 and a distribution server 40 according to the present embodiment. In the description of FIG. 15, the difference from FIG. 7 will be mainly described. The configuration of the distribution server 40 of the present embodiment is similar to the configuration in FIG. 7, but in the present embodiment, optimization setting stored in an optimization setting storage unit 48 is different.

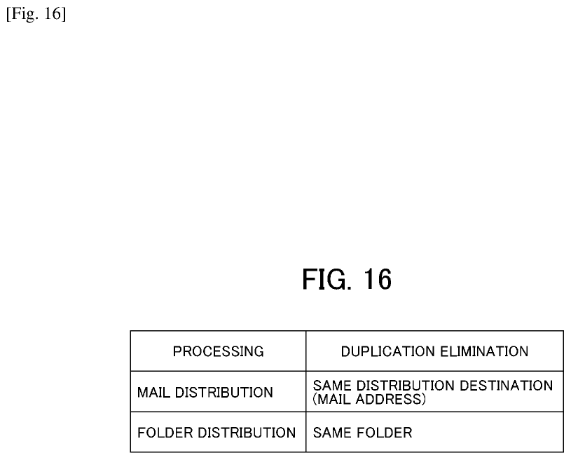

FIG. 16 illustrates optimization setting stored in the optimization setting storage unit 48 of the present embodiment. In the optimization setting, an object to eliminate redundancy is set for each step of processing. For example, in a case of mail distribution, the same distribution destination (mail address) is the object of deletion, and in a case of folder distribution, the same folder (folder name) is the object of deletion.

Therefore, in a case where a plurality of processing set to the optimization setting is included in one workflow, and the same distribution destination is set to each of the processing, a definition information optimization unit 44c performs processing to eliminate the redundancy of the distribution destinations. For example, in a case where the mail distribution A and the mail distribution B have redundant distribution destinations (mail addresses), one of the same distribution destinations is left and the other distribution destination is deleted.

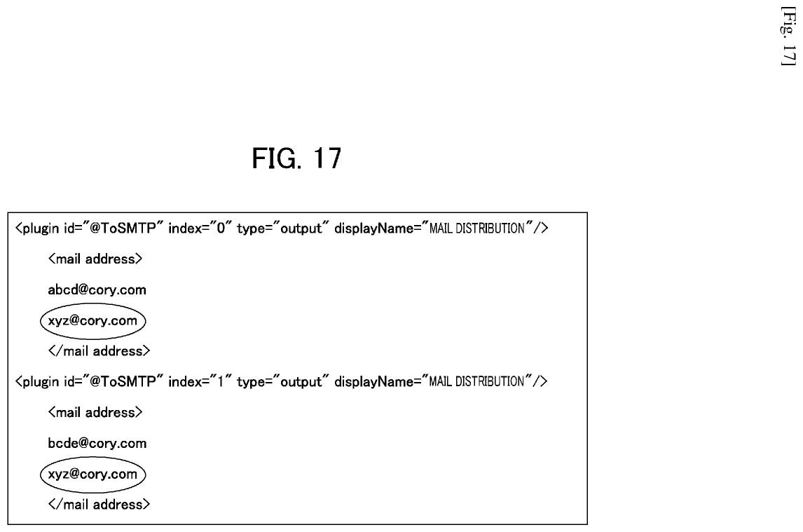

FIG. 17 illustrates a mail address set to two different mail distributions. In FIG. 17, illustration other than the mail distributions is omitted. As illustrated in FIG. 17, since the mail distribution (index=“0”) and the mail distribution (index=“1”) have the same mail address “xyz@cory.com”, the definition information optimization unit 44c deletes one of the mail addresses. In a case where there are three or more mail distributions, one of the same distribution destinations is left and the other distribution destinations are deleted.

In the case where there are two or more mail distributions, the mail address of any of the mail distributions may be deleted. However, for example, it is advisable to leave the mail address of mail distribution farthest from start S. This is because the document for which final processing has been executed can be transmitted.

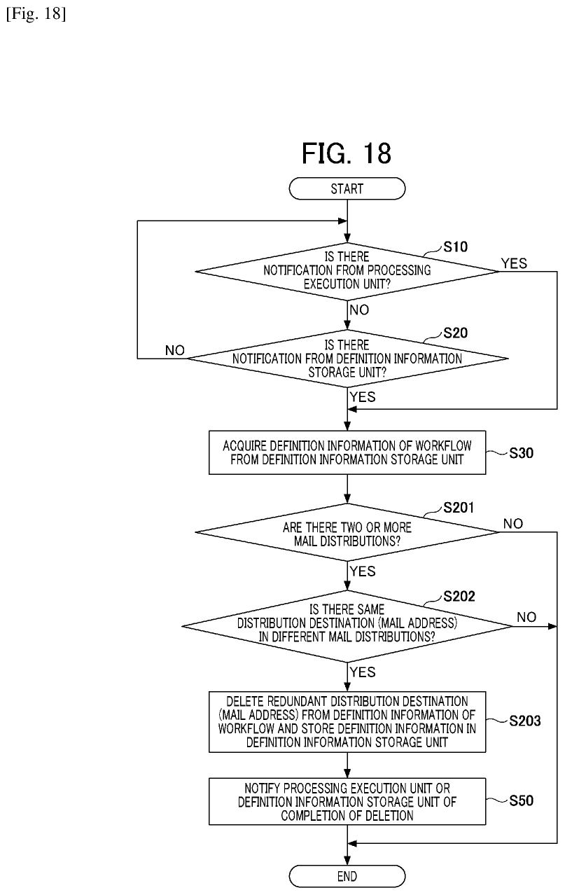

FIG. 18 is an example of a flowchart illustrating a procedure of deleting a redundant distribution destination by the definition information optimization unit 44c. Processing in FIG. 18 is executed during the distribution server 40 being activated. Processing in steps S10 to S30 may be similar to steps S10 to S30 in FIG. 11.

Next, the definition information optimization unit 44c determines whether there are two or more processing (for example, mail distributions) set in the optimization setting in the definition information of the workflow (S201). In a case where there are not two or more processing set in the optimization setting, no distribution destinations are redundant and thus the processing in FIG. 18 is terminated.

In a case where there are two or more processing set in the optimization setting, the definition information optimization unit 44c determines whether each of the two or more processing set to the optimization setting has the same distribution destination (for example, the same mail address) (S202). In a case where there is no same distribution destination, the processing in FIG. 18 is terminated.

In a case where each of the two or more processing has the same distribution destination (for example, the same mail address), the definition information optimization unit 44c deletes the redundant distribution destination (for example, the mail address) from the definition information of the workflow in order to eliminate the redundancy, and stores the definition information of the workflow to the definition information storage unit 47 (S203).

In a case where there are three or more same distribution destinations, one of the same distribution destinations is left. In a case where no distribution destination is left in the mail distribution by deleting the distribution destination, processing of the mail distribution itself may be deleted.

Next, the definition information optimization unit 44c notifies a processing execution unit 42 or a definition information saving unit 43 that the deletion has been completed (S50).

As described above, in a case where there are two or more distribution processing such as mail distributions, and the different distribution processing have the redundant distribution destinations, the distribution server 40 of the present embodiment deletes the redundant distribution destination. Therefore, distribution of the same document to the same distribution destination can be avoided.

Although the best modes for carrying out the present invention have been described by way of embodiments, the present invention is not limited to these embodiments at all, and various modifications and substitutions can be made without departing from the spirit of the present invention.

For example, there may be a plurality of distribution servers. In this case, a distribution server can request another distribution server to execute a plug-in not included in the requestor distribution server, or a distribution server can select another distribution server with a small load and request the another distribution server to execute a plug-in.

Further, a distribution server may communicate with an information processing apparatus (system) having a plug-in and may execute the workflow by requesting the information processing apparatus (system) to execute the plug-in. That is, the workflow may be executed in cooperation with a plurality of apparatuses.

Further, the configuration examples of FIGS. 7, 12, 15, and the like are divided according to the main functions in order to facilitate the understanding of the processing by the scanner device 20 and the distribution server 40. However, the present invention is not limited by the way and name of division of the processing unit. The processing of the scanner device 20 and the distribution server 40 can also be divided into a larger number of processing units according to processing content. Further, one processing unit can be divided to include a larger number of processing.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

In one aspect, the present invention resides on an information processing system (such as the distribution server 40) including: a first storage area (such as the definition information storage unit 47) that stores definition information of a workflow, the workflow including one or more processing each processing having been selected for execution by one or more programs; a second storage area (such as the optimization setting storage unit 48) that stores setting information for setting processing controlled not to be executed; and a processor (such as the CPU 101) configured to change setting of the workflow so as not to execute the processing set by the setting information when executing the one or more processing of the workflow.

In one aspect, the present invention resides on an information processing method including: acquiring (S30), from a first storage area, definition information of a workflow, the workflow including one or more processing each processing having been selected for execution by one or more programs; determining (S102, S202) whether the workflow includes any processing controlled not to be executed, using setting information for setting the processing controlled not to be executed stored in a second storage area; and changing (S40, S103, S203) setting of the workflow so as not to execute the processing set by the setting information when executing the one or more processing of the workflow.

In one aspect, the present invention resides on carrier means such as a recording medium carrying computer readable code for controlling a computer system to carry out the above-described information processing method.

The present invention can be implemented in any convenient form, for example using dedicated hardware, or a mixture of dedicated hardware and software. The present invention may be implemented as computer software implemented by one or more networked processing apparatuses. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium (carrier means). The carrier medium can compromise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority pursuant to 35 U.S.C. § 119(a) to Japanese Patent Application No. 2018-037926, filed on Mar. 2, 2018, in the Japan Patent Office, the entire disclosure of which is hereby incorporated by reference herein.

1-11. (canceled)

12. An information processing system, comprising:
a first memory that stores definition information of a workflow, the workflow including one or more processing, each processing having been selected for execution by one or more programs;
a second memory that stores setting information for setting processing controlled not to be executed for optimization of workflow; and
processing circuitry configured to:
acquire definition information of a workflow to be executed from the first storage area;
determine whether the workflow includes any processing set by the setting information; and
change the definition information of the workflow that is acquired so as not to execute the processing set by the setting information when executing the workflow.

13. The information processing system according to claim 12,
wherein the setting information stored in the second memory sets, as the processing controlled not to be executed, processing that becomes ineffective if such processing is redundantly performed, and
the processing circuitry is further configured to change the definition information of the workflow so as not to redundantly execute the processing set by the setting information when the workflow has the same processing in succession.

14. The information processing system according to claim 12,
wherein at least one of the one or more processing of the workflow includes a plurality of sub-processing executed for the at least one processing, and
the setting information stored in the second memory sets, two or more of the plurality of sub-processing that are redundant, as the processing controlled not to be executed.

15. The information processing system according to claim 12,
wherein the setting information stored in the second memory sets, as the processing controlled not to be executed, processing to distribute information by the information processing system, and
when the workflow includes a plurality of processing to distribution information that are set with a plurality of same distribution destinations, the processing circuitry is further configured to change the definition information of the workflow to keep one distribution destination for the plurality of processing.

16. The information processing system according to claim 15,
wherein, when the plurality of processing to distribute information is a plurality of email distributions set with a plurality of same email addresses, the processing circuitry is further configured to delete the mail address from each one of one or more of the plurality of email distributions other than one email distribution, to leave one email address for the plurality of email distributions.

17. The information processing system according to claim 12, wherein the setting information sets, as the processing controlled not to be executed, processing of the workflow not compatible with other processing, and
the processing circuitry is further configured to change the definition information of the workflow so as not to execute the processing set by the setting information.

18. The information processing system according to claim 17,
wherein the setting information indicates, for each processing of the workflow, a file format of data input to the processing and a file format of data output from the processing, and wherein the workflow includes at least a first processing and a second processing being performed in succession,
the processing circuitry is further configured to determine whether the file format of data output from the first processing is compatible with the file format of data input to the second processing, using the setting information, and based on a determination that the file format of data output from the first processing is not compatible with the file format of data input to the second processing, change the definition information of the workflow so as not to execute the second processing after the first processing.

19. The information processing system according to claim 12, wherein the one or more processing of the workflow are selected by a user via a setting screen.

20. The information processing system according to claim 12, wherein the information processing system is implemented by a server apparatus.

21. An information processing method, comprising:
acquiring, from a first memory, definition information of a workflow, the workflow including one or more processing each processing having been selected for execution by one or more programs;
determining whether the workflow includes any processing set by setting information stored in a second memory, the setting information setting processing controlled not to be executed for optimization of workflow; and
changing the definition information of the workflow that is acquired so as not to execute the processing set by the setting information when executing the workflow.

22. A non-transitory computer-readable recording medium storing computer readable code for controlling a computer system to perform a method, comprising:
acquiring, from a first memory, definition information of a workflow, the workflow including one or more processing each processing having been selected for execution by one or more programs;
determining whether the workflow includes any processing set by setting information stored in a second memory, the setting information setting processing controlled not to be executed for optimization of workflow; and
changing the definition information of the workflow that is acquired so as not to execute the processing set by the setting information when executing the workflow.
